(19) United States
(12) Patent Application Publication
(10) Pub. No.: US 2008/0206027 A1
(43) Pub. Date: Aug. 28, 2008

(54) Apparatus for Carrying a Load

(76) Inventors: Cristiano Manzi, Genova (IT); Giuseppe Pizzoccheri, Piacenza (IT)

Correspondence Address: YOUNG & THOMPSON, 209 Madison Street, Suite 500, ALEXANDRIA, VA, 22314, US

(21) Appl. No.: 11/996,418

(22) PCT Filed: Jul. 17, 2006
(86) PCT No.: PCT/IB06/01960

§ 371 Date: Apr. 9, 2008

(30) Foreign Application Priority Data
Jul. 20, 2005 (IT) BO2005A000487

(51) Int. Cl. B66C 3/00; B66C 19/00; B66C 1/42; G05G 1/08

(52) U.S. Cl. 414/349; 414/785; 414/731; 74/504

(57) ABSTRACT

An apparatus (10) for carrying a load (11), in particular for carrying a container, comprises a framework (12) supported on suitable wheels (16a, 16b, 16c, 16d) and supporting load pick up means (18), the latter being mobile between a lowered load pick up or release position and a lifted load carry position. The supporting framework comprises, in particular, a part (12a, 12b, 12c, 12d) which is fixed to the wheels (16a, 16b, 16c, 16d) and a part (14) supporting the load pick up means (18) and mobile, relative to the fixed part (12a, 12b, 12c, 12d), between at least a lowered position and a lifted position. (FIG. 1)

### TECHNICAL FIELD

The present invention relates to an apparatus for carrying a load, in particular an apparatus for carrying a container.

More specifically, it relates to a so-called “gantry” type carry apparatus.

### BACKGROUND ART

Apparatuses for carrying containers are known which have a supporting framework supported on wheels and a gantry shape consisting of four columns connected to one another at the top, by cross-members, which are suitable for supporting not just the cab and apparatus drive means, but also suitable load pick up means.

In particular, these load pick up means are mobile relative to the upper transversal supporting structure and are driven by four cables, controlled—in pairs—by a winch which has a drum for winding and unwinding a corresponding pair of cables for lifting and lowering the pick up means.

As well as allowing the container to be carried from one zone to another at the railway yard or port where they are used, these known types of apparatuses for carrying a load allow the container to be positioned on top of at least one other container.

For this purpose, these apparatuses have a fixed supporting structure, with very tall and heavy columns, which means that the transfer speed is low and power consumption for movement is high.

In practice, considering the great mass and height of the center of gravity of these known apparatuses, the carry speed is reduced to the detriment of the productivity of these apparatuses at work terminals where loads are handled.

Moreover, according to another disadvantage, the known means allowing the lifting and lowering of the pick up means, which consist of winches and cables, are too structurally complicated, making their production and maintenance expensive.

According to another disadvantage, these prior art gantry apparatuses, which carry the container between their sides, once they release the container, operate with their sides positioned between rows of adjacent containers, and during movements—normally while moving away from the container just released—often strike a container, resulting in damage to the sides or columns of the apparatus.

According to another disadvantage of prior art apparatuses, when maintenance or repairs to machine drive means must be carried out, the apparatus has to be stopped for long periods, meaning loss of operating hours and economic losses for user companies.

### DISCLOSURE OF THE INVENTION

This invention provides an apparatus, particularly of the gantry type, for carrying a load, in particular for carrying a container, the apparatus comprising a framework supported on suitable means for moving the apparatus along a desired path, and supporting means for picking up the load, which are mobile at least between a load pick up or release position and a load carry position; characterised in that the supporting framework comprises a part supported by the movement means, and a part which supports the load pick up means, which is mobile relative to the part supported by the movement means.

In this way, it is possible to obtain an apparatus for carrying a load, in which the supporting framework may be configured as required and, in particular, in such a way that it has a low center of gravity and is, therefore, capable of advantageous operating speeds.

### BRIEF DESCRIPTION OF THE DRAWINGS

These and other technical characteristics of the present apparatus are clearly described in the claims below and its advantages are more apparent from the detailed description which follows, with reference to the accompanying drawings which illustrate preferred embodiments of the invention provided merely by way of example without restricting the scope of the inventive concept, and in which:

FIG. 1 is a schematic side view of a preferred embodiment of the apparatus in accordance with the present invention, in a lifted intermediate carry condition;

FIG. 2 is a perspective schematic view of the preferred embodiment of the apparatus according to the present invention;

FIG. 3 is a schematic side view of the preferred embodiment of the apparatus, in a fully lowered condition;

FIG. 4 is a schematic side view of the preferred embodiment of the apparatus according to the present invention, in a fully lifted condition;

FIG. 5 is a schematic perspective view of the preferred embodiment of the apparatus according to the present invention, in a load pick up means least extended condition;

FIG. 6 is a schematic side view of a first preferred embodiment of the case or module housing the drive means;

FIG. 7 is a schematic side view of a second preferred embodiment of the case or module housing the drive means;

FIGS. 8A to 8D are schematic views of the different steering actions which can be imparted to the wheels of the preferred embodiment of the apparatus.

### DETAILED DESCRIPTION OF THE PREFERRED EMBODIMENTS OF THE INVENTION

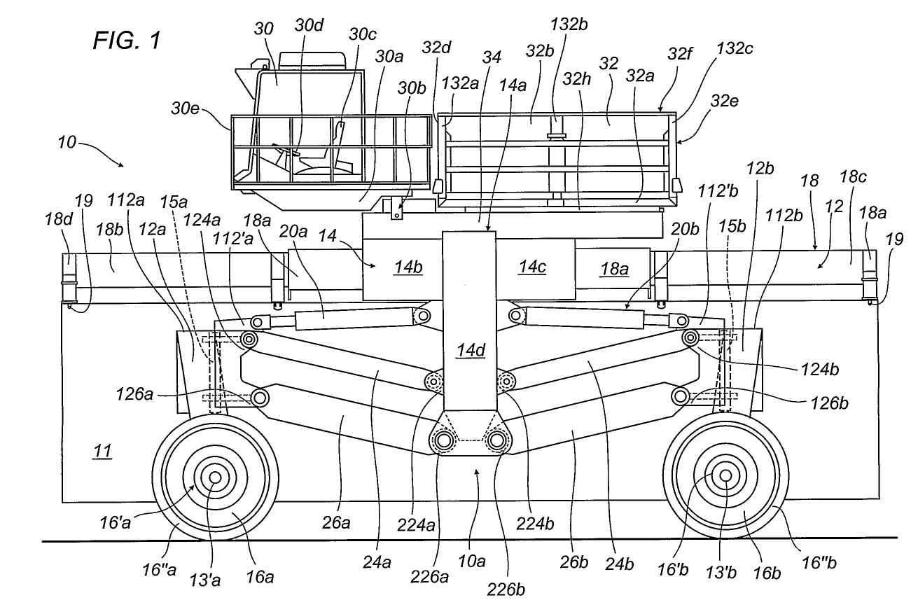

A preferred embodiment 10 of an apparatus for carrying a load, in particular for carrying a container, is schematically illustrated in FIGS. 1 to 4.

The apparatus 10, of the gantry type, comprises a supporting framework, labelled 12 as a whole, which forms a first and a second side 10a, lob of the apparatus, between which the load 11 is carried, the framework being supported by suitable means 16a, 16b, 16c, 16d, which allow the apparatus to move along a desired path.

As illustrated, said movement means consist of a plurality of wheels resting on the ground. In particular, they consist of four wheels 16a, 16b, 16c, 16d, comprising a rim 16′a, 16′b, 16′c, 16′d, and an outer tread element 16″a, 16″b, 16″c, 16″d.

Said wheels 16a, 16b, 16c, 16d are suitably driven to rotate and move the apparatus, respectively, forward and backward, so that the load, in the case in question a container, labelled 11 in the accompanying drawings, can be carried from one zone to another at the work terminal, for example a port or railway yard, where the present apparatus is used.

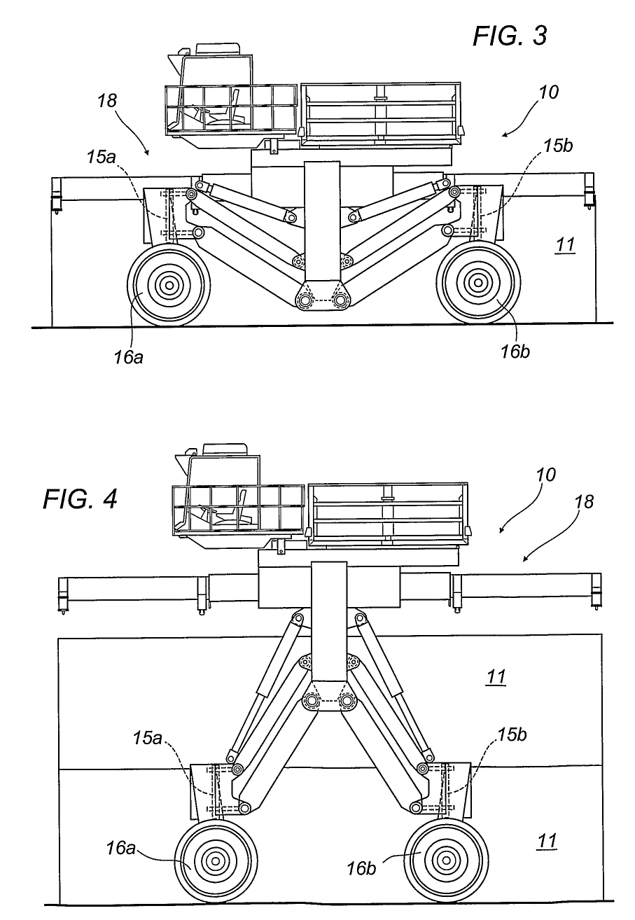

As illustrated, the apparatus also comprises means 18 for picking up the load 11, the means 18 being vertically mobile between a lowered position for picking up or releasing the load, illustrated in FIG. 3, and a lifted carry position, illustrated in FIG. 1.

As is also illustrated in FIG. 4, the load pick up means 18 are also mobile towards and away from an upper lifted position, which allows the positioning or pick up of a container 11 on top of another container 11. Other lifted operating positions may also be imagined.

Advantageously, the present supporting framework comprises, overall, a part 12a, 12b, 12c, 12d, supported by the movement means, or wheels, 16a, 16b, 16c, 16d, and a part 14, supporting the load pick up means 18.

Advantageously, this part 14 of the framework is mobile relative to the part 12a, 12b, 12c, 12d of the framework, supported by the movement means.

In this way, it is possible to obtain an apparatus for carrying a load in which the supporting framework can be prepared according to a desired configuration.

In particular, the part 12a, 12b, 12c, 12d of the framework supported by the movement means 12a, 12b, 12c, 12d is connected to the movement means 16a, 16b, 16c, 16d in a vertically fixed way.

Advantageously, this mobile part 14 of the framework is vertically mobile relative to the part 12a, 12b, 12c, 12d supported by the wheels, that is to say, it can be lifted and lowered relative to the fixed part 12a, 12b, 12c, 12d.

This lifting and lowering of the mobile part of the framework allows the lifting and respectively lowering of the load, between corresponding vertical positions.

In particular, the mobile part of the framework 14 can be moved between a lowered position, illustrated in FIG. 3, in which the pick up means 18 may, alternatively, pick up or release a container, and a lifted position, illustrated in FIG. 1, which allows the load to be carried towards a zone where it will be used.

In this way, it is possible to obtain an apparatus which, in the carry condition, may have a low center of gravity, as illustrated in FIG. 1, and which is therefore capable of advantageous operating speeds.

Moreover, the part 14 of the framework supporting the load pick up means 18 can move to an upper lifted position, illustrated in FIG. 4, suitable for allowing the load 11 pick up or release operation, in a lifted position, in particular in a position above another container 11.

With this apparatus configuration, it is possible to avoid the use of tall and heavy apparatus fixed supporting columns seen in the prior art, and so to obtain a lighter apparatus, which is an advantage in terms of the speed at which the various load carrying operations can be carried out.

Advantageously, the load 11 pick up means 18 are integral with the mobile part 14 of the framework, as described more clearly below.

There are also advantageous means, labelled 20a, 20b, 20c and 20d, for lifting and lowering the load pick up means.

Advantageously, these lifting and lowering means 20a, 20b, 20c, 20d for the load pick up means 18 are part of the apparatus supporting framework.

In particular, as illustrated, these load lifting and lowering means 20a, 20b, 20c, 20d are located between the fixed part 12a, 12b, 12c, 12d of the framework and the mobile part 14, supporting the load pick up means 18.

Advantageously, the wheels 16a, 16b, 16c, 16d are supported by supporting heads 12a, 12b, 12c, 12d.

As illustrated, the heads 12a and 12b, supporting the wheels 16a and 16b of the side 10a of the apparatus, like the heads 12c, 12b, on the other side of the apparatus which support the other wheels 16c, 16d of the side lob of the apparatus, are longitudinally spaced from one another.

As illustrated, below the supporting head of the respective wheel there extends an extension shaft 15a, 15b, 15c, 15d, connecting the head block to a fork 13a, 13b, 13c, 13d below, which has a hub for securing the wheel rim. FIG. 1 shows only the hubs 13′a and 13′b for connection of the wheels 16a, 16b.

In particular, the wheels which move the apparatus can be driven both by transmissions driven by an internal combustion engine, or by electric motors.

There are advantageous connecting means (20a, 20b, 20c, 20d, 24a, 24b, 24c, 24d, 26a, 26b, 26c, 26d) between the part 12a, 12b, 12c, 12d, supported by the movement means 16a, 16b, 16c, 16d, and the part 14, supporting the load pick up means 18, the connecting means forming part of the apparatus supporting framework, in particular part of the respective side 10a, 10b of the supporting framework.

According to another advantageous aspect, the load lifting means are hydraulic actuators 20a, 20b, 20c, 20d, extending, vertically and longitudinally, between corresponding heads 12a, 12b, 12c, 12d of the vertically fixed part of the framework, and the vertically mobile part 14 of the framework.

In this way, rapid load lifting and lowering are possible, advantageously increasing apparatus productivity.

In practice, the hydraulic actuators, or cylinders 20a, 20b, 20c, 20d are part of the supporting framework of the machine, in particular part of the sides 10a, 10b of the supporting framework, and allow a relatively light and simplified apparatus supporting structure to be obtained.

As illustrated, the lifting and lowering actuators 20a, 20b, 20c, 20d extend from the upper surface 112a, 112b, 112c, 112d of the corresponding supporting head 12a, 12b, 12c, 12d.

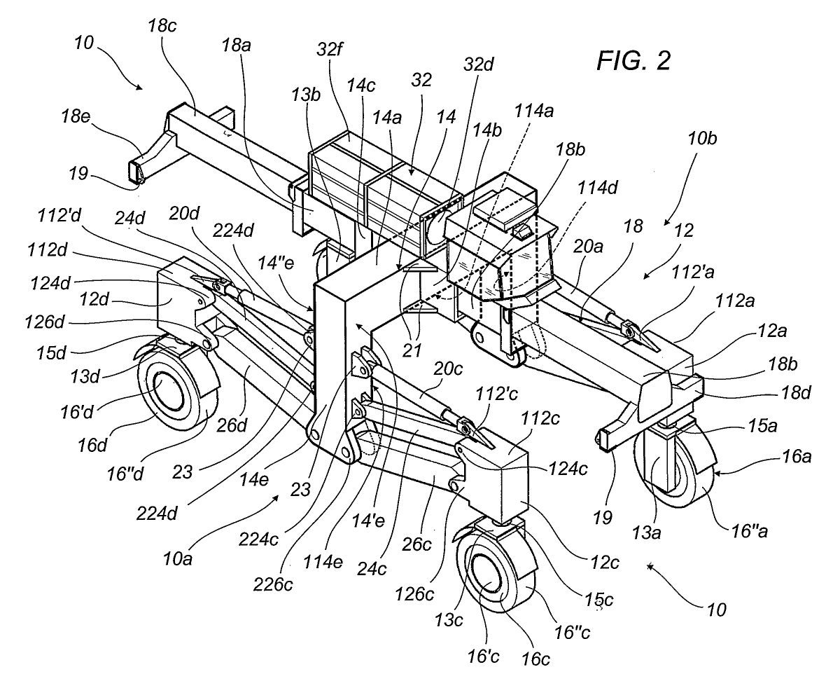

For this purpose, as illustrated particularly in FIGS. 1 and 2, extending from the upper surface of each head there is a vertical pivot connection plate for the end of the corresponding rod of the respective hydraulic cylinder 20a, 20b, 20c, 20d. Said pivot connection plates are labelled 112′a, 112′b, 112′c, 112′d in the accompanying drawings.

As illustrated, the actuator means are linear actuators, in particular hydraulic cylinders, each having a cylinder from which a rod extends.

The linear actuators 20a, 20b, 20c, 20d are mobile between an extended position, corresponding to the apparatus fully lifted condition, illustrated in FIG. 4, and a retracted position, illustrated in FIG. 3, corresponding to the apparatus fully lowered condition.

Moreover, with the actuator elements 20a, 20b, 20c, 20d in an intermediate extension condition, a lifting means 18 lifted configuration is obtained which corresponds to a load carry condition, as illustrated in FIG. 1.

As illustrated, the load pick up means 18 comprise a main portion 18a and a first and a second projecting extension beam 18b, 18c, supporting corresponding cross-members 18d, 18e with coupling elements 19, suitable for operating in conjunction with corresponding coupling portions at the top substantially at the edges of the container 11.

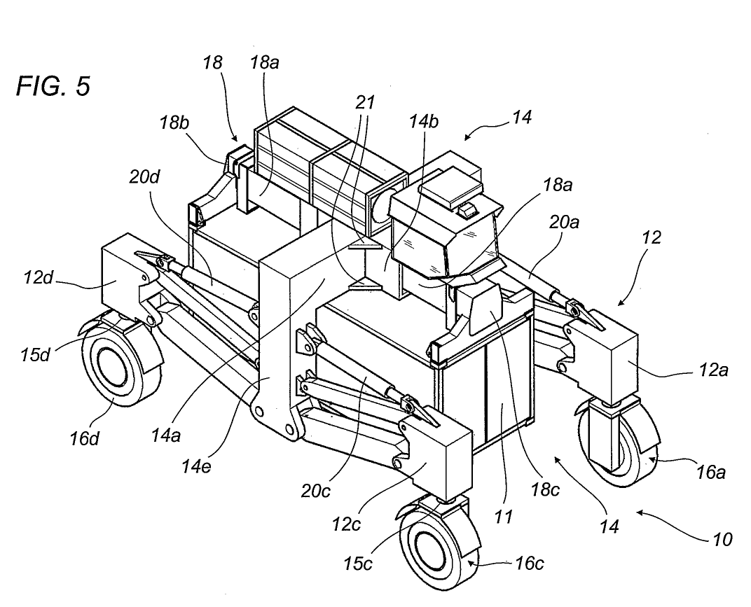

As shown in FIGS. 2 and 5, the projecting extension beams 18b, 18c can be operated telescopically between a retracted position for supporting a shorter container, illustrated in FIG. 5, and an extended position for supporting a longer container, illustrated in FIG. 2.

The apparatus supporting framework comprises a transversal structural frame element 14, forming the mobile part of the framework. The structural frame element 14 comprises a transversal beam 14a, positioned at the top, from whose central zone there extend longitudinally corresponding tubular elements 14b, 14c for supporting the main body 18a of the pick up means 18.

As can be seen in FIG. 2, labelled 21 and 21, there are corresponding horizontal stiffening and connection plates, having a general triangular shape, between the lateral wall of the longitudinal element 14b and the adjacent surface of the front transversal wall of the transversal beam 14a. There are similar horizontal connection plates for connecting the other lateral wall of the element 14b to the adjacent surface of the front transversal wall of the beam 14a, and for connecting the opposite lateral walls of the element 14c to corresponding surfaces of the rear transversal wall of the transversal element 14a.

As illustrated, the transversal structural frame element 14 is a portal element, having opposite first and second lateral uprights 14d, 14e, extending downwards from the lateral ends of the transversal beam 14a.

As illustrated, the actuator elements 20a, 20b, 20c, 20d, in particular their cylinders, connect to the transversal structural frame element, at the lateral uprights 14d, 14e. For this purpose, there are joint connection plates 23, between the end of the hydraulic cylinder 20a, 20b, 20c, 20d and the relative upright.

As illustrated, the joint connection plates 23 extend from corresponding front and rear transversal surfaces 14′e and 14″e of the structural frame element 14.

In practice, whilst the transversal element 14 forms the transversal component of the framework supporting structural frame, the actuator elements 20a, 20b, 20c, 20d form the longitudinal structural frame, that is to say, the sides, of the supporting framework.

As illustrated, the portal element 14 has a general “U” shape with an inner surface 114a, 114d, 114e having a profile which follows the outer profile of the load to be handled, in particular of a container 11. In particular, the inner profile of the portal element 14 has a first and a second vertical section 114d (illustrated with a dashed line) and 114e, the vertical sections being transversally spaced from one another and formed by the inner wall of the respective columns 14d, 14e.

The inner surface of the portal element 14 is completed by an upper horizontal section 114a, formed by the lower side of the transversal beam 14a. Extending from the lateral ends of the horizontal section 114a there are the vertical sections 114d, 114e, on the inner side of the columns 14d and 14e, forming an inner profile having a general “U” shape for the present mobile element 14.

In particular, the actuator elements 20a, 20b, 20c, 20d form structural frame struts, at least in the lifted configurations of the present apparatus.

As illustrated, the actuator elements 20a, 20b, 20c, 20d extend longitudinally, at the sides of the pick up and load zone.

The fact that the actuator elements 20a, 20b, 20c, 20d also form part of the apparatus supporting framework allows an apparatus to be obtained which has a small number of components and, therefore, a low weight, advantageous in terms of cost, operating speed and drive power consumption.

Advantageously, there are also means for guiding the vertical movement of the load pick up means 18. In particular, these are guide means for the vertical movement of the mobile part 14 of the framework, supporting the pick up means 18.

In a particularly advantageous way, said vertical movement guide means comprise four-bar linkage means. However, use of any other means for guiding the vertical movement of the mobile element 14, for example a system of levers not constituting a four-bar linkage, could also be imagined.

The present means for guiding the movement of the mobile part 14 also form part of the apparatus framework, forming part of its longitudinal structural frame, that is to say, the sides of the supporting framework. As illustrated, in the preferred embodiment, the means (actuators and levers) forming the longitudinal sides of the supporting framework extend from the front and rear sides of the respective columns 14d, 14e of the portal element 14.

These guide means extend between each wheel supporting head 12a, 12b, 12c, 12d and the corresponding lateral uprights 14d, 14e of the portal element 14.

As illustrated, the linkage means extend, in particular, from linkage projections, extending from the face of the respective head facing inwards or the center of the apparatus, to the corresponding front and rear transversal faces of the portal element 14 uprights, in any event being in a vertical position lower than the actuator means 20a, 20b, 20c, 20d.

In particular, for each side there are opposite first and second linkage means respectively 24a, 26a and 24b, 26b, at the side 10a, and 24c, 26c and 24d and 26d, at the opposite side 10b.

In particular, each four-bar linkage guide element has a first linkage arm 24a, 24b, 24c, 24d with a smaller cross-section, the top of which is connected between an upper end of the corresponding head and a substantially intermediate point of the corresponding portal upright.

Moreover, each four-bar linkage guide element has a second linkage arm 26a, 26b, 26c, 26d with a larger cross-section, which is connected between the lower end of the corresponding head and a lower enlargement of the corresponding portal upright.

In particular, each upper lever 24a, 24b, 24c, 24d extends between corresponding connecting portions 124a, 224a, 124b, 224b, 124c, 224c, 124d, 224d, on the respective head and on the respective upright, whilst each lower lever 26a, 26b, 26c, 26d extends between corresponding connecting portions 126a, 226a, 126b, 226b, 126c, 226c, 126d, 226d, respectively on the relative head and on the relative upright.

As illustrated, inserted in said connecting portions are corresponding swivel pins of the levers 24a, 24b, 24c, 24d, 26a, 26b, 26c, 26d and of the actuators 20a, 20b, 20c, 20d, which allow their free rotation relative to the parts to which the ends of the levers and actuators are connected.

As illustrated, the connecting portions for the lower levers 26a, 26b, 26c, 26d form a fork-shaped portion extending downwards from the respective column 14d, 14e.

According to another advantageous aspect, there is an apparatus driving or control position or cab 30, which, as illustrated, is supported above the framework, and in particular, on the mobile supporting means 14.

Advantageously, in the present apparatus, the control position is vertically mobile together with the load 11.

As illustrated, in particular in FIG. 1, the control position comprises a lower supporting base 30a, suitably connected, at 30b, to a supporting platform 34 (described in more detail below), a seat 30c, and apparatus control means 30d, which can be operated by the operator. Moreover, a barrier 30e extends around the cab 30 to prevent personnel from falling.

The mobile position 30 allows the operator to remain close to the load 11 to be coupled up or released, so that the operations performed are easier.

Advantageously, there are also means for housing the apparatus drive means, the housing means being supported on the framework mobile supporting means 14.

These housing means consist of a closed case, labelled 32 in the accompanying drawings, supported on the platform or body 34, the top being fixed to the framework, in particular to the transversal structural frame element 14, in a transversally central position relative to the latter.

As illustrated, the driving position or cab 30 is in an extended front position of the longitudinal supporting platform 34. In a balanced way, the housing means, for respective drive means, extend to the rear of the control position 30 on the side of the beam 14 opposite that from which the cab 30 extends.

As illustrated, the lower supporting platform 34 for the cab 30 and the case 32 housing the drive means also rests above the central longitudinal elements 14b, 14c of the transversal structural frame element 14.

Advantageously, the housing means 32, for the respective drive means, are removably connected to the apparatus framework. In this way, when repairs or maintenance are required on the drive means, the entire module 32 can be removed from the apparatus and substituted with another module, so that the apparatus can be rendered operative extremely rapidly. This drastically reduces apparatus down times.

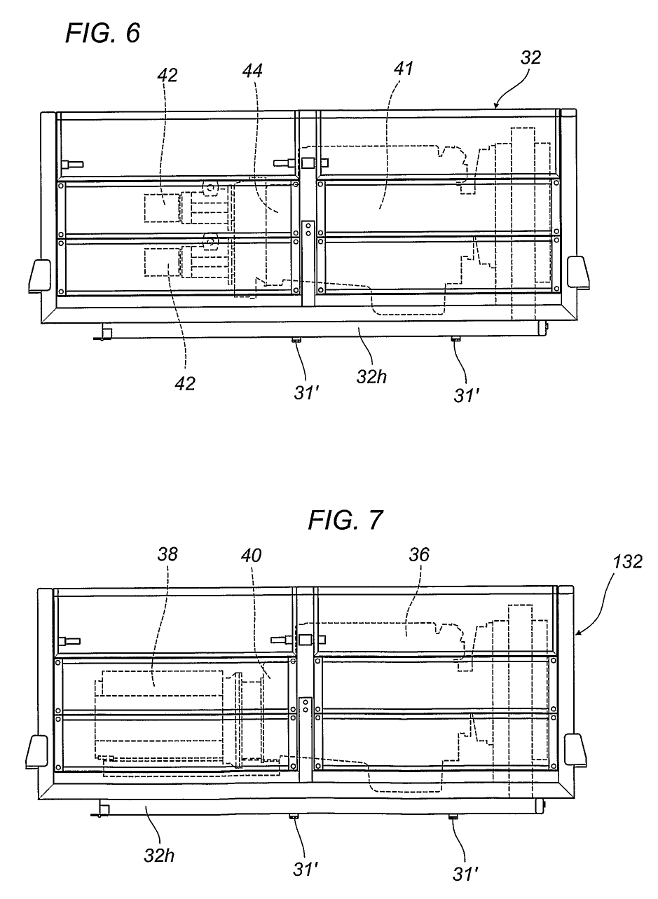

In particular, the removable connecting means comprise bushings, of which only the bushings 31′, 31′—preferably with internal threading—are illustrated in FIG. 6, on the housing means lower supporting surface, in which corresponding bolts (not illustrated in the accompanying drawings) are inserted, which go into corresponding holes in the apparatus supporting framework. These holes in the framework are also not illustrated in detail in the accompanying drawings. Other removable means for connecting the module to the apparatus may also be imagined.

As illustrated, in particular in FIGS. 1 and 2, the housing means 32 for the drive means comprise a lower supporting surface 32a and a plurality of containment walls 32b, 32c, 32d, 32e, 32f, at least one of which can be opened, to allow access to the drive means. In particular, all of the walls 32b, 32c, 32d, 32e, 32f may be opened, for the easiest possible access and to allow rapid repairs and maintenance on the parts housed inside.

In particular, as illustrated, the housing means for the drive means comprise a plurality of containment sides 32b, 32c, 32d, 32e and an upper containment wall 32f.

Moreover, as illustrated, the housing means for the drive means comprise a plurality of uprights on which the sides rest, of which only a few—labelled 132a, 132b, 132c —are illustrated in FIG. 2. Corresponding cross-members and longitudinal members may be used to support the sides or walls of the module 32. However, these cross-members and longitudinal members are not labelled in the accompanying drawings.

As illustrated, advantageously, the housing means for the drive means comprise a lower base 32h for connection to the apparatus framework.

The housing means for the drive means comprise hoisting points or brackets for lifting means in the maintenance workshop, to facilitate removal from or positioning on the apparatus. However, the case 32 hoisting points or brackets are not illustrated in detail in the accompanying drawings.

The case or module 32 houses an internal combustion engine, as well as any hydraulic or electrical components for transmission of the power, and any electronic components for controlling the apparatus.

Advantageously, the case 32 housing the drive means has walls with suitable acoustic insulation properties to reduce the noise, in particular if an internal combustion engine is used.

As already indicated, there are main drive means for the present apparatus.

As shown in FIG. 6, the drive means comprise not just the internal combustion engine, labelled 41, but also hydraulic oil pumping means, in particular consisting of a first and a second hydraulic pump 42, 42, connected to the engine 41 shaft by corresponding connecting means 44.

It may be seen how, advantageously, the engine 41 is supported above the apparatus supporting framework, with the hydraulic pumping means 42 and 42 and the relative connecting means 40. In this way, repair and maintenance operations to be carried out without bringing the drive means down to ground level are still very much facilitated.

In particular, as illustrated, the housing means 32 support and contain the engine 41 and the hydraulic pumping means 42 and 42, as well as the connecting means 44 between them.

As shown in FIG. 7, according to another preferred embodiment, the drive means, in respective housing means 132 similar to the housing means 32, comprise an internal combustion engine 36 and an electric generator 38, which is connected to the engine shaft by corresponding connecting means 40.

Similarly to the previous first preferred embodiment of the housing means or module 32, in this second preferred embodiment 132, the engine 41 is supported above the apparatus supporting framework, with the electric generator means 38 and the relative connecting means 40.

Similarly to the previous first preferred embodiment of the housing means or module 32, in this second preferred embodiment, the housing means support the engine 36 and the electric generator means 38, as well as the connecting means 40 between them.

According to another aspect, the housing means support hydraulic or electrical transmission or connecting means, not illustrated in detail in the accompanying drawings, which allow power to be transmitted to user devices, such as hydraulic motors or hydraulic actuators, respectively for driving the wheels, the steering wheel and lifting, or alternatively it is transmitted to electric motors and other electrically powered devices.

Operation of the apparatus is briefly described below. Starting from a lowered load pick up condition, illustrated in FIG. 3, the apparatus uses suitable operation of the hydraulic actuators to lift the load to the position illustrated in FIG. 1, which allows the container to be lifted off the ground, and makes it possible to transfer the container to a suitable zone where it will be used.

Once the apparatus has arrived at a container on which the container carried must be loaded, the hydraulic circuit activates the hydraulic actuators 20a, 20b, 20c, 20d, to obtain an apparatus lifted position, shown in FIG. 4, in which the length or longitudinal distance between the wheel axles is reduced, and in which the container can be positioned on top of another container, with the sides of the apparatus on opposite sides of the containers 11 and 11.

In this lifted position the container carried can therefore be released on top of another container, as shown in FIG. 4. In this apparatus lifted position it would also be possible to pick up the container 11 on top, to carry it to another zone where it will be used.

According to another advantageous aspect, there are steering means for the movement means, that is to say, for the apparatus wheels 16a, 16b, 16c, 16d.

As illustrated, the steering means comprise a vertical shaft 15a, 15b, 15c, 15d for wheel 16a, 16b, 16c, 16d support and rotation, and means for rotationally driving the corresponding shaft (not illustrated in the accompanying drawings), on the supporting head 12a, 12b, 12c, 12d of the respective wheel 16a, 16b, 16c, 16d.

There are also electronic steering wheel control means.

As illustrated, the steering wheel control means are designed to steer the movement means 16a, 16b, 16c, 16d independently of one another.

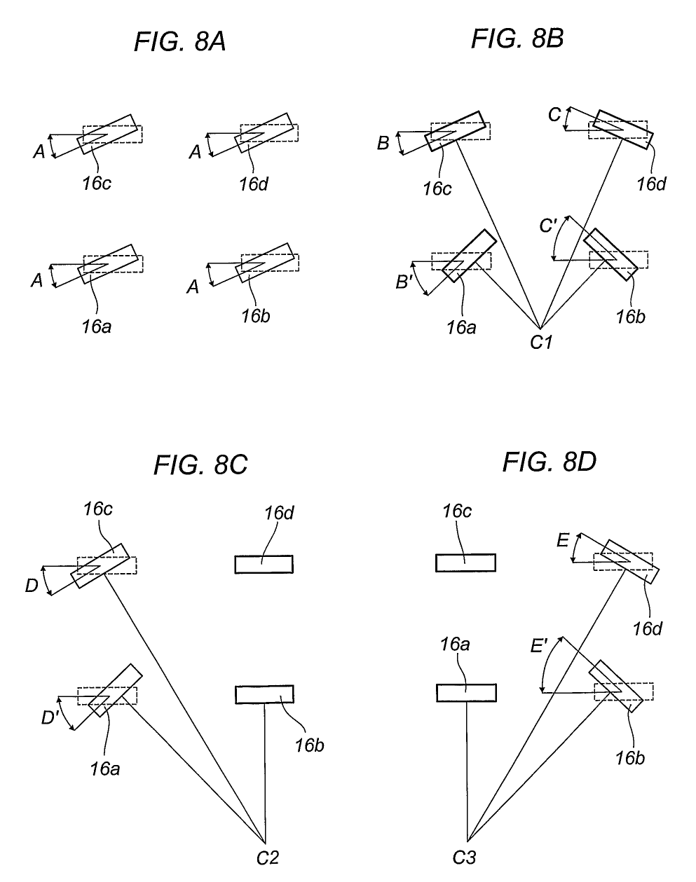

As shown in FIG. 8A, these electronic steering wheel control means allow all of the wheels 16a, 16b, 16c, 16d to be steered in the same angular direction, illustrated by angle A in FIG. 8A relative to the normal direction of travel, so that the apparatus can move at an angle without curving.

This movement is particularly advantageous when an apparatus which has unloaded a container held between its sides alongside other containers must move away from the latter. If, as often happens, the apparatus is positioned with one of its sides particularly close to a respective container, performing such a movement at an angle or sideways, the apparatus can move away from the container without striking it. In the prior art for example when performing a curved section although the front or rear longitudinal end of the apparatus was moved away from the container, the other longitudinal end struck the container.

Advantageously, as illustrated in FIG. 8B, the steering means are also designed to steer the front wheels 16a, 16caccording to a respective angular direction, shown by angles B and B′, relative to the normal direction of travel, and the rear wheels 16b, 16d according to a respective angular direction C and C′ relative to the normal direction of travel, so that the apparatus covers a curved path relative to a shared center of rotation C1.

Again advantageously, as illustrated in FIG. 8C, the steering means are designed to steer the pair of front wheels 16a, 16c according to a respective angular direction, shown by angle D, D′, relative to the normal direction of travel, so that the apparatus covers a curved path relative to the center of rotation C2, which is aligned with the line perpendicular to the rear wheels 16b, 16d.

Again advantageously, as illustrated in FIG. 8D, the steering means are designed to steer the pair of rear wheels 16b, 16d according to a respective angular direction, shown by angle E, E′, relative to the normal direction of travel, so that the apparatus covers a curved path relative to the center of rotation C3, which is aligned with the line perpendicular to the front wheels 16a, 16c.

In practice, with the front wheels and the rear wheels set at a different angle to the longitudinal direction and, in any case, set at different angles to one another, as illustrated in FIG. 8B, the apparatus is able to cover the curved section in an improved way. Curved sections can also be covered by steering the front wheels or the rear wheels only, as illustrated in FIGS. 8C and 8D.

According to another aspect, there are control means for the movement means which allow the front part 12a, 12c of the apparatus to be moved towards or away from the rear part 12b, 12d.

In particular, there are control means for the rotation or travel of the wheels which allow the front and rear wheels to be rotated in opposite directions to one another, particularly to promote longitudinal movements of the wheels towards or away from one another during lifting and lowering.

In practice, for framework mobile part 14 lifting operations, during which the front wheels 16a, 16c and the rear wheels 16b, 16d move towards one another, the front wheels 16a, 16c are driven in such a way that they rotate backwards, whilst the rear wheels 16b, 16d are driven in such a way that they rotate forwards.

In contrast, for framework mobile part 14 lowering operations, during which the front wheels 16a, 16c and the rear wheels 16b, 16d move away from one another, the front wheels 16a, 16c are driven in such a way that they rotate forward, whilst the rear wheels 16b, 16d are driven in such a way that they rotate backwards.

Basically, a light apparatus for carrying a load is obtained, which is advantageous in terms of transfer speed, and which can advantageously be kept high. More rapid accelerations and decelerations than those of prior art apparatuses are possible.

Moreover, considering the significant structural simplification compared with prior art apparatuses, the present apparatus allows particularly advantageous construction costs.

An apparatus for carrying a load is provided, having a supporting framework with variable positioning, that is to say, able to assume a plurality of different operating configurations.

The apparatus supporting framework has different height configurations, which the operator can select as required. Basically, it is an apparatus with a supporting framework with variable height.

Moreover, the apparatus supporting framework has different length configurations. Basically, it is an apparatus with a supporting framework with variable length.

The invention described has evident industrial applications and can be modified and adapted without thereby departing from the scope of the inventive concept. Moreover, all the details of the invention may be substituted by technically equivalent elements.

1. An apparatus (10), especially of the gantry type, for carrying a load (11), in particular for carrying a container, the apparatus comprising a framework (12) supported on suitable means (16a, 16b, 16c, 16d) for moving the apparatus along a respective path, and supporting load pick up means (18), the latter being mobile at least between a load pick up or release position and a load carry position; the apparatus being characterised in that the supporting framework comprises a part (12a, 12b, 12c, 12d) which is supported by the movement means (16a, 16b, 16c, 16d), and a part (14) which supports the load pick up means (18), the part (14) supporting the load pick up means (18) being mobile relative to the part (12a, 12b, 12c, 12d) supported by the movement means.

2. The apparatus according to claim 1, characterised in that the part (12a, 12b, 12c, 12d) of the framework supported by the movement means (12a, 12b, 12c, 12d) is connected to the movement means (16a, 16b, 16c, 16d) in a vertically fixed way.

3. The apparatus according to claim 1, characterised in that the part (14) supporting the load pick up means (18) moves vertically relative to the part (12a, 12b, 12c, 12d) supported by the movement means.

4. The apparatus according to claim 1, characterised in that the mobile part (14) moves between at least a load (11) pick up or release position and a load (11) carry position.

5. The apparatus according to claim 4, characterised in that the load pick up or release position is a lowered position.

6. The apparatus according to claim 4, characterised in that the load carry position is a lifted position.

7. The apparatus according to claim 4, characterised in that the part (14) of the framework supporting the pick up means (18) can move to an upper lifted load (11) pick up or release position.

8. The apparatus according to claim 1, characterised in that there are connecting means (20a, 20b, 20c, 20d, 24a, 24b, 24c, 24d, 26a, 26b, 26c, 26d) between the part (12a, 12b, 12c, 12d) supported by the movement means (16a, 16b, 16c, 16d) and the part (14) supporting the load pick up means (18).

9. The apparatus according to claim 8, characterised in that the connecting means (20a, 20b, 20c, 20d, 24a, 24b, 24c, 24d, 26a, 26b, 26c, 26d) form part of the apparatus supporting framework.

10. The apparatus according to claim 9, characterised in that the connecting means (20a, 20b, 20c, 20d, 24a, 24b, 24c, 24d, 26a, 26b, 26c, 26d) form a side of the supporting framework.

11. The apparatus (10) according to claim 1, characterised in that there are means (20a, 20b, 20c, 20d) for lifting and lowering the load pick up means (18).

12. The apparatus according to claim 11, characterised in that the means (20a, 20b, 20c, 20d) for lifting and lowering the load pick up means (18) form part of the apparatus supporting framework.

13. The apparatus according to claim 11 [[or 12]], characterised in that the means (20a, 20b, 20c, 20d) for lifting and lowering the load pick up means (18) are located between a part (12a, 12b, 12c, 12d) supported by the movement means (16a, 16b, 16c, 16d) and a part (14) supporting the load pick up means (18).

14. The apparatus according to any claim 1, characterised in that the framework comprises actuator means (20a, 20b, 20c, 20d).

15. The apparatus according to any claim 1, characterised in that, actuator means (20a, 20b, 20c, 20d) are used to move the load pick up means (18).

16. The apparatus according to claim 14, characterised in that the actuator means consist of at least one linear actuator (20a, 20b, 20c, 20d).

17. The apparatus according to claim 16, characterised in that each linear actuator (20a, 20b, 20c, 20d) can move to a fully extended position, corresponding to the apparatus fully lifted condition.

18. The apparatus according to claim 16, characterised in that each linear actuator (20a, 20b, 20c, 20d) can move to a retracted position, corresponding to the apparatus fully lowered condition.

19. The apparatus according to claim 16, characterised in that each linear actuator (20a, 20b, 20c, 20d) can move to an intermediate extension position, corresponding to the load lifted carry condition.

20. The apparatus according to claim 1, characterised in that the movement means comprise a plurality of wheels (16a, 16b, 16c, 16d).

21. The apparatus according to any claim 1, characterised in that the movement means (16a, 16b, 16c, 16d) are connected to respective supporting heads (12a, 12b, 12c, 12d).

22. The apparatus according to claim 21, characterised in that for each side of the apparatus there is a first and a second supporting head (12a, 12b and 12c, 12d) which are longitudinally spaced from one another.

23. The apparatus according to claim 21, characterised in that the lifting and lowering means (20a, 20b, 20c, 20d) extend from the upper surface (112a, 112b, 112c, 112d) of the corresponding head (12a, 12b, 12c, 12d).

24. The apparatus according to claim 21, characterised in that an actuator part (20a, 20b, 20c, 20d) extends from the basic head (12a, 12b, 12c, 12d).

25. The apparatus according to claim 1, characterised in that the pick up means (18) are integral with the mobile part (14) of the framework.

26. The apparatus according to claim 1, characterised in that the supporting framework comprises a transversal structural frame element (14).

27. The apparatus according to claim 26, characterised in that the transversal element of the supporting framework has a transversal beam (14a).

28. The apparatus according to claim 1, characterised in that the pick up means (18) comprise a portion (18a, 18b) extending longitudinally from the mobile part (14).

29. The apparatus according to claim 26, characterised in that the transversal structural frame element (14) is a portal element.

30. The apparatus according to claim 26, characterised in that the transversal structural frame element (14) has a first and a second lateral upright (14d, 14e).

31. The apparatus according to claim 30, characterised in that the first and second lateral uprights (14d, 14e) extend downwards from the transversal beam (14a).

32. The apparatus according to claim 26, characterised in that it has a single transversal structural frame element (14) in a substantially central longitudinal position on the apparatus.

33. The apparatus according to claim 14, characterised in that the actuator means form supporting framework struts.

34. The apparatus according to claim 14, characterised in that the actuator means (20a, 20b, 20c, 20d) extend at the side of the load pick up zone.

35. The apparatus according to claim 14, characterised in that the actuator means (20a, 20b, 20c, 20d) extend upwards.

36. The apparatus according to claim 14, characterised in that the actuator means (20a, 20b, 20c, 20d) extend longitudinally.

37. The apparatus according to claim 1, characterised in that there are means for guiding the vertical movement of the load pick up means (18).

38. The apparatus according to claim 1, characterised in that there are means for guiding the movement of the mobile part (14) of the supporting framework.

39. The apparatus according to claim 37, characterised in that the guide means are between the part (12a, 12b, 12c, 12d) supported by the movement means (16a, 16b, 16c, 16d) and the part (14) supporting the load pick up means (18).

40. The apparatus according to claim 37, characterised in that the means for guiding the vertical movement comprise lever means (26a, 28a, 26b, 28b, 26c, 28c, 26d, 28d).

41. The apparatus according to claim 37, characterised in that the means for guiding the vertical movement comprise four-bar linkage means (26a, 28a, 26b, 28b, 26c, 28c, 26d, 28d).

42. The apparatus according to claim 37, characterised in that for the respective side of the apparatus there are first and second guide means (26a, 28a, 26b, 28b and 26c, 28c, 26d, 28d) operating on the mobile supporting means (14) in opposite longitudinal directions.

43. The apparatus according to claim 37, characterised in that for the respective side of the apparatus there are opposite first and second guide means (26a, 28a, 26b, 28b and 26c, 28c, 26d, 28d) extending from the mobile supporting means (14) in opposite longitudinal directions.

44. The apparatus according to claim 1, comprising a control position (30).

45. The apparatus according to claim 44, characterised in that the control position (30) is vertically mobile.

46. The apparatus according to claim 44, characterised in that the control position (30) moves together with the load (11).

47. The apparatus according to claim 44, characterised in that the control position (30) is supported by the mobile supporting means (14).

48. The apparatus according to claim 1, characterised in that there are means (32, 132) for housing the drive means.

49. The apparatus according to claim 48, characterised in that the means (32, 132) for housing the drive means are supported on the mobile supporting means (14).

50. The apparatus according claim 48, characterised in that the means (32) for housing the drive means are supported in a position above the apparatus framework.

51. The apparatus according to claim 48, characterised in that the means (32) for housing the drive means are supported at the rear of the control position (30).

52. The apparatus according to claim 48, characterised in that the means (32) for housing the drive means are removably connected to the apparatus framework.

53. The apparatus according to claim 48, characterised in that the means (32) for housing the drive means comprise a lower supporting surface (32a).

54. The apparatus according to claim 48, characterised in that the means (32) for housing the drive means comprise a plurality of containment walls (32b, 32c, 32d, 32e, 32f), at least one of which can open, allowing access to the drive means.

55. The apparatus according to claim 48, characterised in that the means (32) for housing the drive means comprise a lower base (32h) for connection to the apparatus framework.

56. The apparatus according to claim 1, characterised in that there are means for steering the movement means (16a, 16b, 16c, 16d).

57. The apparatus according to claim 56, characterised in that the steering means comprise a shaft (15a, 15b, 15c, 15d) for supporting and rotating the wheel (16a, 16b, 16c, 16d) and means for rotationally driving the shaft.

58. The apparatus according to claim 56, characterised in that there are steering wheel control means.

59. The apparatus according to claim 58, characterised in that the steering wheel control means are electronic.

60. The apparatus according to claim 56, characterised in that there are steering wheel control means designed to steer the movement means (16a, 16b, 16c, 16d) independently of one another.

61. The apparatus according to claim 56, characterised in that the steering means are designed to steer the wheels (16a, 16b, 16c, 16d) in the same angular direction (A) relative to the normal direction of travel, allowing the apparatus to move without curving.

62. The apparatus according to claim 56, characterised in that the steering means are designed to steer the front and rear wheels (16a, 16b, 16c, 16d) in a respective angular direction (B, B′ and C, C′) relative to the normal direction of travel, allowing the apparatus to follow a curved path.

63. The apparatus according to claim 56, characterised in that the steering means are designed to steer the pair of front wheels (16a, 16b) in a respective angular direction (D, D′) relative to the normal direction of travel, allowing the apparatus to follow a curved path.

64. The apparatus according to claim 56, characterised in that the steering means are designed to steer the pair of rear wheels (16c, 16d) in a respective angular direction (E, E′) relative to the normal direction of travel, allowing the apparatus to follow a curved path.

65. The apparatus according to claim 56, characterised in that the means for steering the movement means (16a, 16b, 16c, 16d) are supported on the corresponding supporting head (12a, 12b, 12c, 12d) for the respective movement means.

66. The apparatus according to claim 1, characterised in that there are apparatus drive means (36, 38, 40, 42, 42, 44).

67. The apparatus according to claim 66, characterised in that the drive means comprise an engine (36, 41).

68. The apparatus according to claim 67, characterised in that the engine (36, 41) is an internal combustion engine.

69. The apparatus according to claim 66, characterised in that the drive means comprise an electric generator (38).

70. The apparatus according to claim 66 , characterised in that the drive means comprise hydraulic pumping means (42, 42).

71. The apparatus according to claim 66, characterised in that the housing means support the engine (36, 41).

72. The apparatus according to claim 66, characterised in that the housing means support the electric generator means (38).

73. The apparatus according to claim 66, characterised in that the housing means support the hydraulic pumping means (42, 42).

74. The apparatus according to claim 66, characterised in that the housing means support disengageable connecting means for power transmission means.

75. The apparatus according to claim 66, characterised in that the engine (36 or 41) is supported above the apparatus supporting framework.

76. The apparatus according to claim 66, characterised in that the electric generator means (38) are supported above the apparatus supporting framework.

77. The apparatus according to claim 66, characterised in that the hydraulic pumping means (42, 42) are supported above the apparatus supporting framework.

78. The apparatus according to claim 1, characterised in that there are means designed to cause the front part of the apparatus (12a, 12c) to move towards or away from the rear part (12b, 12d).

79. The apparatus according to claim 78, characterised in that there are control means for the movement means which allow the front part of the apparatus (12a, 12c) to be moved towards or away from the rear part (12b, 12d).

80. The apparatus according to claim 20, characterised in that there are means for controlling the forward and backward rotation of the wheels, allowing the front wheels (16a, 16c) and/or the rear wheels (16b, 16d) to rotate in such a way as to promote longitudinal movements of the front and rear wheels (16a, 16b, 16c, 16d) towards or away from one another.

81. The apparatus according to claim 20, characterised in that there are means for controlling the direction of rotation or travel of the wheels, allowing the front wheels (12a, 12c) and the rear wheels (12b, 12d) to rotate in opposite angular directions.

82. The apparatus according to any of the foregoing claims, characterised in that the mobile part (14) of the framework forms an inner surface (114a, 114d, 114e) which matches the outer profile of the load (11), in particular the outer profile of a container (11).

83. The apparatus according to claim 1, characterised in that the mobile part (14) of the framework forms an inner surface (114a, 114d, 114e) designed to allow the passage of the load (11), in particular of a container (11).

84. The apparatus according to any of claim 1, characterised in that it has a supporting framework with variable height.

85. The apparatus according to claim 1, characterised in that it has a supporting framework with variable length.

86. The apparatus according to claim 14, characterised that the actuator means (20a, 20b, 20c, 20d) are between the part (12a, 12b, 12c, 12d) supported by the movement means (16a, 16b, 16c, 16d) and the part (14) supporting the load pick up means (18).
